(19) United States
(12) Patent Application Publication
(10) Pub. No.: US 2018/0115683 A1
(43) Pub. Date: Apr. 26, 2018

(54) MULTIVIEW CAMERA SYNCHRONIZATION SYSTEM AND METHOD

(71) Applicant: Flux Planet, Inc., Seoul (KR)

(72) Inventor: Sang Yup LEE, Seoul (KR)

(21) Appl. No.: 15/336,173

(22) Filed: Oct. 27, 2016

(30) Foreign Application Priority Data
Oct. 21, 2016 (KR) 10-2016-0137705

(51) Int. Cl. H04N 5/06; H04N 5/247; H04N 5/235

(52) U.S. Cl. CPC H04N 5/06; H04N 5/2351; H04N 5/2353; H04N 5/247

(57) ABSTRACT

Provided is a multiview camera synchronization system for controlling an exposure clock of a camera capturing a moving image at a preset frame rate. The multiview camera synchronization system includes: a reference value determining unit determining a reference value based on input data acquired by the camera for a first set interval; a clock adjusting unit acquiring, for a second set interval of generating a reference signal flickering at a frequency equal to the preset frame rate, input data by the reference signal and adjusting a clock of the camera until acquiring input data equal to or greater than reference value; and a synchronization clock setting unit setting a clock of acquiring input data of the reference value as a synchronization clock of the camera.

### CROSS-REFERENCE TO RELATED APPLICATION

This application claims the benefit of priority of Korean Patent Application No. 10-2016-0137705, filed on Oct. 21, 2016, in the Korean Intellectual Property Office, the disclosure of which is incorporated herein in its entirety by reference.

### BACKGROUND

### 1. Field

One or more embodiments relate to multiview camera synchronization systems and methods, and more particularly, to multiview camera synchronization systems and methods that may generate a reference signal recognizable by cameras themselves and synchronize the internal clocks of the cameras based on the reference signal.

### 2. Description of the Related Art

A multiview image is a field of image processing that provides various views of various directions to a user by spatially synthesizing images captured by one or more cameras. Images captured at the same time by cameras should be used in order for images of different views to be produced as one scene. For this purpose, in the related art, an external signal is provided to a plurality of cameras in order to capture images at the same time.

### SUMMARY

One or more embodiments are to synchronize the clocks of a plurality cameras for capturing a multiview image.

Additional aspects will be set forth in part in the description which follows and, in part, will be apparent from the description, or may be learned by practice of the presented embodiments.

According to one or more embodiments, a multiview camera synchronization system for controlling an exposure clock of a camera capturing a moving image at a preset frame rate includes: a reference value determining unit determining a reference value based on input data acquired by the camera for a first set interval; a clock adjusting unit acquiring, for a second set interval of generating a reference signal flickering at a frequency equal to the preset frame rate, input data by the reference signal and adjusting a clock of the camera until acquiring input data equal to or greater than reference value; and a synchronization clock setting unit setting a clock of acquiring input data of the reference value as a synchronization clock of the camera.

The reference signal may be one of a light, a sound, a movement, and a radio frequency (RF) signal.

According to one or more embodiments, a multiview camera synchronization system for controlling an exposure clock of a camera capturing a moving image at a preset frame rate includes: a reference value determining unit determining a reference brightness value by calculating brightness values of images acquired by the camera for a first set interval; a clock adjusting unit adjusting an exposure clock of the camera until acquiring an image having a brightness value equal to or greater than the reference brightness value for a second set interval of generating a reference signal flickering at a frequency equal to the preset frame rate; and a synchronization clock setting unit setting an exposure clock of acquiring an image having a brightness value equal to or greater than the reference brightness value as a synchronization clock of the camera.

The reference brightness value may be a maximum brightness value among the brightness values of the images acquired for the first set interval.

A signal longer than a frame period of the camera may be generated for a certain time in the first set interval.

The clock adjusting unit may adjust the exposure clock by using a binary search method.

The clock adjusting unit may repeat, until the brightness value is equal to or greater than the reference brightness value: a first operation of calculating a brightness value of an image acquired for an exposure time of a frame period; a second operation of determining whether the brightness value is equal to or greater than the reference brightness value; and a third operation of adjusting an exposure clock of a next frame period forward or backward by a preset value when the brightness value is smaller than the reference brightness value.

The reference signal flickering at the frequency equal to the preset frame rate may be a signal flickering to turn on for a time equal to the length of an exposure time of the camera.

The synchronization clock may be used in a photographing process of the camera.

According to one or more embodiments, a multiview camera synchronization method for controlling an exposure clock of a camera capturing a moving image at a preset frame rate includes: a reference value determining operation of determining a reference brightness value by calculating brightness values of images acquired by the camera for a first set interval; a clock adjusting operation of adjusting an exposure clock of the camera until acquiring an image having a brightness value equal to or greater than the reference brightness value for a second set interval of generating a reference signal flickering at a frequency equal to the preset frame rate; and a synchronization clock setting operation of setting an exposure clock of acquiring an image having a brightness value equal to or greater than the reference brightness value as a synchronization clock of the camera.

The reference brightness value may be a maximum brightness value among the brightness values of the images acquired for the first set interval.

A signal longer than a frame period of the camera may be generated for a certain time in the first set interval.

The clock adjusting operation may adjust the exposure clock by using a binary search method.

The clock adjusting operation may repeat, until the brightness value is equal to or greater than the reference brightness value: a first operation of calculating a brightness value of an image acquired for an exposure time of a frame period; a second operation of determining whether the brightness value is equal to or greater than the reference brightness value; and a third operation of adjusting an exposure clock of a next frame period forward or backward by a preset value when the brightness value is smaller than the reference brightness value.

The reference signal flickering at the frequency equal to the preset frame rate may be a signal flickering to turn on for a time equal to the length of an exposure time of the camera.

The synchronization clock may be used in a photographing process of the camera.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating a configuration of a multiview camera synchronization system according to an embodiment;

FIG. 2 is a diagram illustrating an internal configuration of a clock synchronization system;

FIG. 3 is a diagram illustrating frames and exposures according to an embodiment;

FIG. 4 is a diagram illustrating a process of setting a synchronization clock according to an embodiment;

FIG. 5 illustrates a sequential execution order of a multiview camera synchronization method according to an embodiment; and

FIG. 6 illustrates a sequential execution order of an exposure clock adjusting method according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The following detailed description of the inventive concept refers to the accompanying drawings that illustrate embodiments of the inventive concept. The embodiments are described in sufficient detail to enable those of ordinary skill in the art to implement the inventive concept. It will be understood that various embodiments of the inventive concept are not necessarily mutually exclusive while being different from each other. For example, particular shapes, structures, and features described herein may be modified from some embodiments to other embodiments without departing from the spirit and scope of the inventive concept. Also, it will be understood that the position or arrangement of individual components in the respective embodiments may be modified without departing from the spirit and scope of the inventive concept. Thus, the following detailed description should be considered in a descriptive sense only and not for purposes of limitation, and the scope of the inventive concept should be construed as including the appended claims and the equivalents thereof. In the drawings, like reference numerals will denote like elements throughout various aspects.

Hereinafter, various embodiments of the inventive concept will be described in detail with reference to the accompanying drawings so that those of ordinary skill in the art may easily implement the inventive concept.

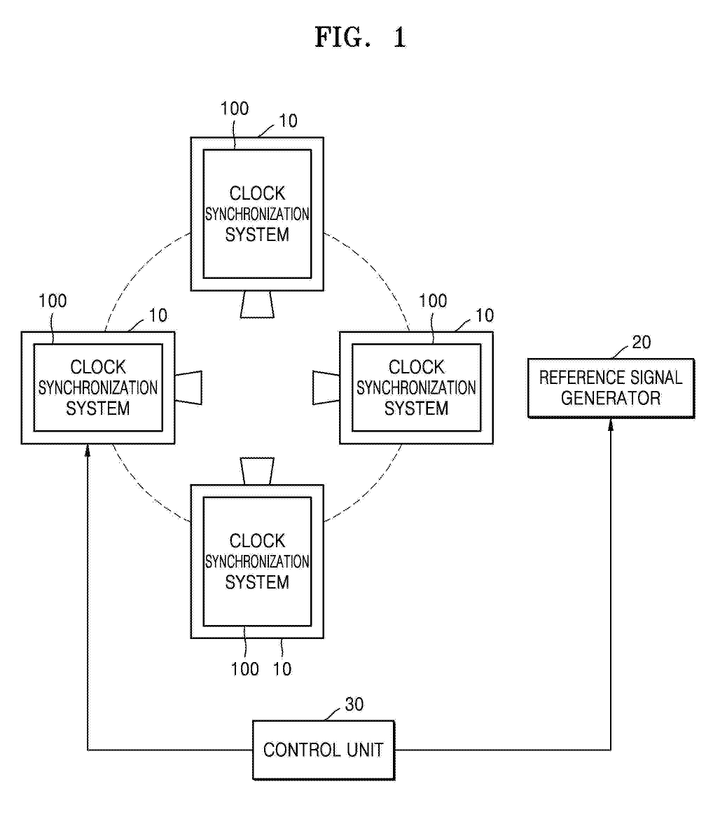

FIG. 1 is a diagram illustrating a configuration of a multiview camera synchronization system according to an embodiment.

Referring to FIG. 1, the multiview camera synchronization system according to an embodiment includes a plurality of cameras 10, a reference signal generator 20, a control unit 30, and a clock synchronization system 100 included in the cameras 10.

First, according to an embodiment, the multiview camera synchronization system includes a plurality of cameras 10. Herein, the camera 10 may be a photographing device for generating a multiview image, particularly a multiview video (moving image). Although only four cameras 10 are illustrated in FIG. 1, the inventive concept is not limited thereto and a plurality of cameras 10 may be used to capture a multiview image. Herein, various known cameras 10 having a video capturing function may be used without limitation regardless of model and type, and the cameras 10 may not necessarily have the same model and type. According to an embodiment, the cameras 10 include a clock synchronization system 100. The clock synchronization system 100 may be implemented on firmware included in the camera 10; however, the inventive concept is not limited thereto and an implementation method and an implementation position may be freely selected in order to implement an operation of the clock synchronization system 100 described later. The operation of the clock synchronization system 100 will be described later in more detail.

Also, according to an embodiment, the multiview camera synchronization system includes a reference signal generator 20. As a device for generating a signal to synchronize the clocks of the cameras 10, the reference signal generator 20 may be any device that generates a signal recognizable by the camera 10. As an example, the reference signal generator 20 may be an illumination device, a speaker device, a movement generator, a network signal generator, or a radio frequency (RF) signal generator, and the signal generated by the reference signal generator 20 may be a light, a sound, a movement, a network signal, or an RF signal. According to an embodiment, the camera 10 may include a separate device for recognizing the signal generated by the reference signal generator 20.

According to an embodiment, under the control of the control unit 30, the reference signal generator 20 may generate a signal for a certain interval or may generate a flickering reference signal. In particular, according to an embodiment, the reference signal generator 20 may generate a reference signal that flickers at a frequency equal to a frame rate of the camera 10. For example, when the reference signal generator 20 is an illumination device, the reference signal generator 20 may generate a light signal flickering at a frequency equal to the frame rate of the camera 10 under the control of the control unit 30.

According to an embodiment, the control unit 30 may be configured to control the camera 10 or the reference signal generator 20. The control unit 30 may control the basic settings of the respective cameras 10 such as the exposure time and the frame rate of the camera 10 or may control the on/off of the reference signal generator 20. According to an embodiment, the control unit 30 may not directly control the exposure clock of the cameras 10.

In the case of using a plurality of cameras 10 to obtain a multiview image, even if the cameras 10 have the same frame rate, when a frame-by-frame exposure clock, that is, the timing of obtaining a frame-by-frame exposure image mismatches between the cameras 10, an accurate multiview image may not be obtained. That is, even if a plurality of cameras 10 start photographing at the same time, when a per-frame exposure clock mismatches between the cameras 10, an accurate multiview image may not be obtained. In the related art, since an external signal is used to synchronize the exposure clocks, the cost for providing a separate signal system may increase in order to transmit the external signal to the cameras 10 and the photographing environment may be constrained due to the wired connection between the cameras 10. Also, when not three or four cameras 10 but tens or hundreds of cameras 10 are used, the implementation thereof may be physically impossible.

In order to solve these problems, according to the inventive concept, the multiview camera synchronization system 10 may generate a reference signal recognizable by the cameras 10 themselves and synchronize the internal clocks of the cameras 10 based on the reference signal. The inventive concept is intended to synchronize the clock according to the beginning of the frame, not the clock in which an image sensor of the camera is operated. According to the inventive concept, since the clock synchronization between the cameras 10 may be performed even without a further connection cable between the cameras 10, the physical environmental constraints such as the operation and disposition of the cameras 10 may be eliminated and thus photographing may be performed in more various environments. Also, since the hardware for separately processing the external signal may not be required and may be implemented on the firmware in the camera 10, it may be applied also to the general camera (10) equipment and thus the high scalability may be ensured.

Hereinafter, the inventive concept will be described in more detail focusing on the configuration of the clock synchronization system 100. Herein, the clock synchronization system 100 may be similarly applied to the respective cameras 10.

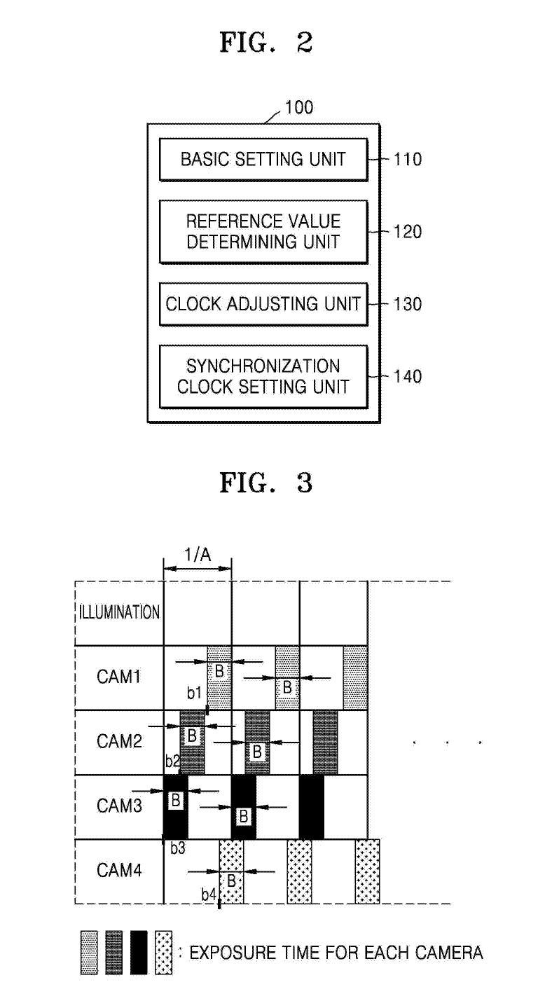

FIG. 2 is a diagram illustrating an internal configuration of a clock synchronization system.

Referring to FIG. 2, the clock synchronization system 100 according to an embodiment includes a basic setting unit 110, a reference value determining unit 120, a clock adjusting unit 130, and a synchronization clock setting unit 140.

First, the basic setting unit 110 may determine an exposure time and a basic frame rate (frames per second (fps)) of the camera 10. Herein, the frame rate may refer to the number of images captured per second by the camera 10 to capture a moving image (video), and may refer to a screen generation frequency. Also, a frame period may refer to a period according to the frame rate. Also, the exposure time may refer to the length of an exposure interval, and the exposure clock may refer to the start time point of an exposure for each frame period.

FIG. 3 is a diagram illustrating frames and exposures according to an embodiment.

FIG. 3 illustrates a case where the frame rate of a first camera Cam1, a second camera Cam2, a third camera Cam3, and a fourth camera Cam4 according to an embodiment is set to “A”, wherein the frame period is “1/A”. In the frame period 1/A, the exposure time may be set to “B”. Herein, in the case of no separate adjustment, the start time points of the exposure times may be different from each other, and the exposure times may start respectively at exposure clocks b1, b2, and b3 in the respective frame periods 1/A. That is, as illustrated in FIG. 3, even when the respective cameras 10 are set to have the same frame rate A and the same exposure time B, the respective cameras 10 may have different exposure times. When the exposure times are different from each other, since the timings of capturing images are different from each other, an accurate multiview image may not be obtained. Thus, the inventive concept provides a method of synchronizing different exposure clocks.

Next, the reference value determining unit 120 may determine a reference value based on the input data acquired by the camera 10 for a first set interval. In the first set interval, the reference signal generator 20 may be controlled to generate a reference signal for a certain time, wherein the certain time may be longer than the frame period of the camera 10. In this case, the reference value may be the maximum input data among the input data acquired by the camera 10 for the first set interval.

According to an embodiment, when the reference signal generator 20 is an illumination device, the reference value determining unit 120 determines a reference brightness value by calculating the brightness values of images acquired by the camera 10 for the first set interval. In this case, the reference value may be the maximum brightness value among the brightness values of the images acquired for the first set interval.

Next, the clock adjusting unit 130 may acquire, for a second set interval of generating a reference signal flickering at a frequency equal to the frame rate, input data by the reference signal and adjust a clock of the camera 10 until acquiring input data equal to or greater than reference value. According to an embodiment, by using a binary search method, the clock adjusting unit 130 may adjust the clock of the camera 10 until satisfying the reference value. Also, the reference signal flickering for the second set interval at the frequency equal to the frame rate of the camera 10 may be a signal flickering to turn on for the time equal to the length of the exposure time of the camera 10.

As an example, according to an embodiment, when the reference signal generator 20 is an illumination device, the clock adjusting unit 130 may adjust the exposure clock of the camera 10 until acquiring an image having a brightness value equal to or greater than the reference brightness value for the second set interval of generating the reference signal flickering at the frequency equal to the frame rate. In this case, the clock adjusting unit 130 may repeat, until the brightness value is equal to or greater than the reference brightness value, a first operation of calculating a brightness value of an image acquired for the exposure time of the frame period, a second operation of determining whether the brightness value is equal to or greater than the reference brightness value, and a third operation of adjusting the exposure clock of the next frame period forward or backward by a preset value when the brightness value is smaller than the reference brightness value.

Next, the synchronization clock setting unit 140 may set the clock of acquiring the input data of the reference value as a synchronization clock of the camera 10. As an example, according to an embodiment, when the reference signal generator 20 is an illumination device, the synchronization clock setting unit 140 may set the exposure clock of acquiring an image having a brightness value equal to or greater than the reference brightness value as the synchronization clock of the camera 10. Accordingly, the clocks of the cameras 10 may be synchronized with respect to the same reference value. According to the inventive concept, the multiview cameras 10 may provide a multiview image by using the set synchronization clock. When the clock of the camera 10 is synchronized once, since the difference between the system clock of the cameras 10 and the system clock of the control unit 30 may be calculated, the synchronization in the subsequent photographing of the multiview camera 10 may be performed based on the system clock of the control unit 30.

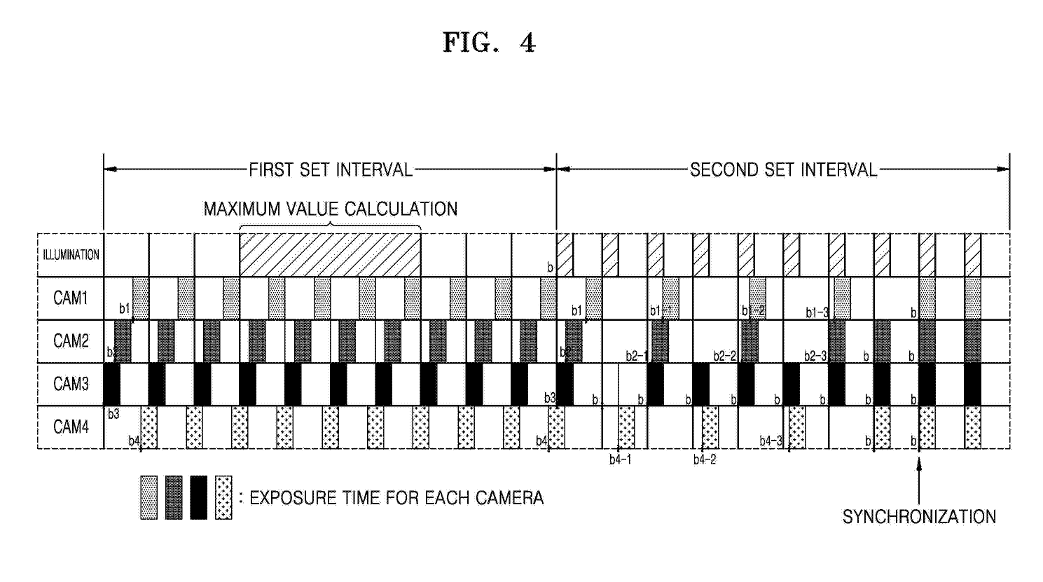

Hereinafter, for an understanding of the inventive concept, a method of setting the synchronization clock will be described with reference to FIG. 4, focusing on an embodiment in which the reference signal generator 20 is an illumination device.

FIG. 4 is a diagram illustrating a process of setting a synchronization clock according to an embodiment.

Referring to FIG. 4, it may be seen that the exposure clocks of the first to fourth cameras Cam1, Cam2, Cam3, and Cam4 are respectively b1, b2, b3, and b4 in the initial stage. Also, in the embodiment of FIG. 4, the cameras 10 have the same frame rate and the same exposure time.

First, a reference signal (i.e., a light signal) longer than the frame period of the cameras 10 is generated for a certain time in the first set interval. During the generation of the light signal, since the image acquired by the cameras 10 have the maximum brightness value, the maximum brightness value of the images may be acquired for each camera 10. In the first set interval, for the interval in which the light signal is not generated, the images may have the minimum brightness value. In this case, the maximum brightness value may be determined as the reference brightness value according to an embodiment. Alternatively, in another embodiment, the reference brightness value may be determined as a value near the maximum brightness value based on the maximum brightness value.

In the second set interval, an illumination corresponding to the reference signal generator 20 may generate a flickering light signal. In this case, the light signal may flicker to turn on for a time equal to the length of the exposure time of the cameras 10. Also, the light signal may be controlled to turn on at the same clock “b” in each frame period.

First, since the first camera Cam1 has the exposure clock b1, the exposure clock of the camera 10 is adjusted until acquiring an image having a brightness value equal to or greater than the reference brightness value. In more detail, since the image acquired with the exposure clock b1 is the image acquired without the light signal, the image brightness may not satisfy the reference brightness value. Thus, the exposure clock of the next frame is adjusted to b1-1, and an image is acquired with the adjusted exposure clock to calculate the brightness value thereof. In this case, as for the adjustment of the exposure clock, the exposure clock of the current frame may be adjusted forward or backward by using a binary search method. For example, as illustrated in FIG. 4, when the image acquired at the exposure clock b1 does not satisfy the reference brightness value, the exposure clock is moved forward to b1-1. Since the image may be acquired to have a higher brightness value at the exposure clock b1-1 than at the exposure clock b1, the exposure clock b1-1 is moved forward to b1-2 in the next frame. In the same way, the exposure clock is moved to b1-3, and the exposure clock “b” at the time when the brightness value of the image satisfies the maximum brightness value is set as the synchronization clock of the camera 10. If the brightness value of the image decreases (that is, moves away from the reference value) in the case of moving the exposure clock forward according to the binary search method, the exposure clock is moved backward in the next frame. In the same way, the exposure clock may be adjusted also for the second to fourth cameras 10. For example, in the case of the third camera Cam3, since the original exposure clock is “b”, the initially acquired image may have the brightness equal to or greater than the reference value and thus the original exposure clock itself is set as a synchronization exposure clock. In this way, the exposure clock satisfying the reference brightness value may be found, and the exposure clock of the cameras 10 becomes “b” equal to the exposure clock of the light signal. That is, all the exposure clocks of the cameras 10 may be synchronized with “b”.

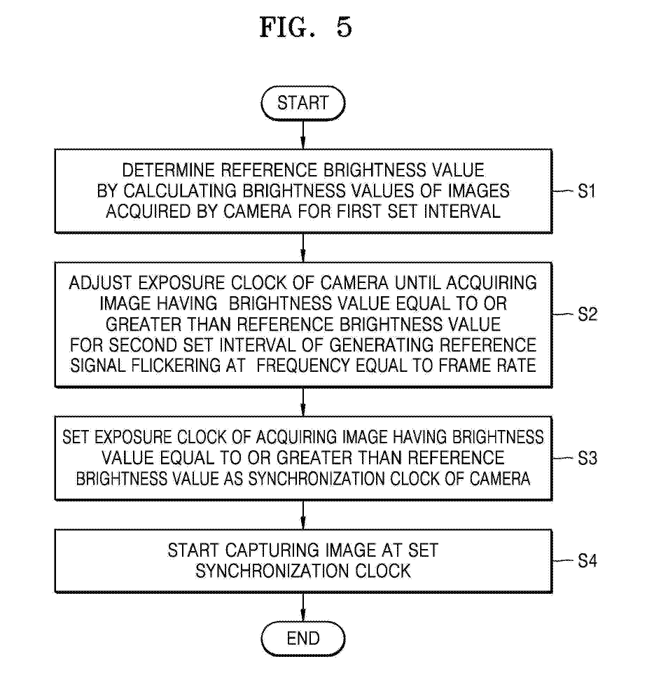

FIG. 5 illustrates a sequential execution order of a multiview camera (10) synchronization method according to an embodiment.

Referring to FIG. 5, first, the method determines the reference brightness value by calculating the brightness values of the images acquired by the camera 10 for the first set interval (S1). Next, the method adjusts the exposure clock of the camera 10 until acquiring an image having a brightness value equal to or greater than the reference brightness value for the second set interval of generating the reference signal flickering at a frequency equal to the frame rate (S2). Next, the method sets the exposure clock of acquiring an image having a brightness value equal to or greater than the reference brightness value as the synchronization clock of the camera 10 (S3). Next, the method starts capturing an image at the set synchronization clock (S4).

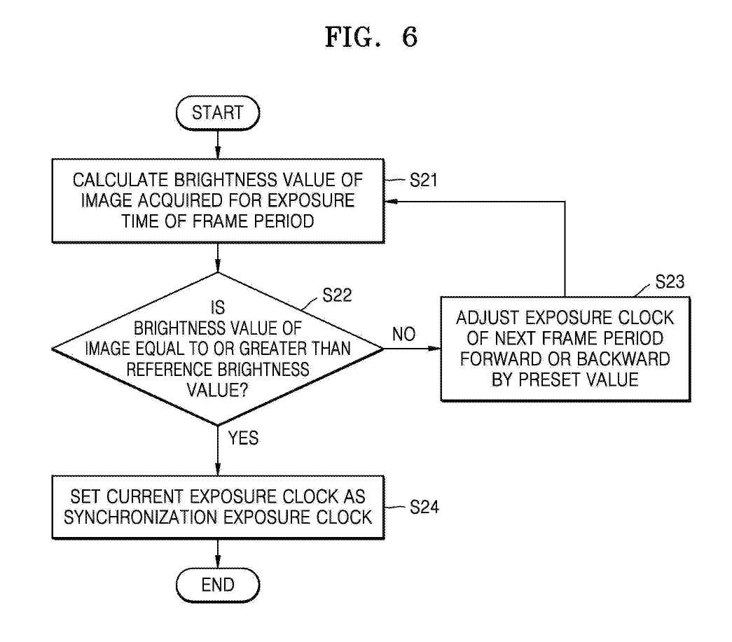

FIG. 6 illustrates a sequential execution order of an exposure clock adjusting method according to an embodiment.

FIG. 6 illustrates a sequential order of operation S2 of FIG. 5. Referring to FIG. 6, first, the method calculates the brightness value of an image acquired for the exposure time of the frame period (21). Next, the method determines whether the brightness value of the image is equal to or greater than the reference brightness value (S22). When the brightness value of the image is smaller than the reference brightness value, the method adjusts the exposure clock of the next frame period forward or backward by a preset value (S23). On the other hand, when the brightness value of the image is equal to or greater than the reference brightness value, the method sets the current exposure clock as the synchronization exposure clock (S24).

Particular implementations described herein are merely embodiments, and do not limit the scope of the inventive concept in any way. For the sake of conciseness, descriptions of related art electronic configurations, control systems, software, and other functional aspects of the systems may be omitted. Also, the connection lines or connection members between various elements illustrated in the drawings represent examples of functional connections and/or physical or logical connections between the various elements, and various alternative or additional functional connections, physical connections, or logical connections may be present in practical apparatuses. Also, no element may be essential to the practice of the inventive concept unless the element is specifically described as “essential” or “critical”.

The use of the terms “a”, “an”, and “the” and similar referents in the context of the specification (especially in the context of the following claims) may be construed to cover both the singular and the plural. Also, recitation of a range of values herein are merely intended to serve as a shorthand method of referring individually to each separate value falling within the range, unless otherwise indicated herein, and each separate value is incorporated into the specification as if it was individually recited herein. Also, the operations of the method described herein may be performed in any suitable order unless otherwise indicated herein or otherwise clearly contradicted by the context. The scope of the inventive concept is not limited to the above-described operation order. All examples or exemplary terms (e.g., “such as”) provided herein are merely used to describe the inventive concept in detail, and the scope of the inventive concept is not limited by the examples or exemplary terms unless otherwise claimed. Also, those of ordinary skill in the art will readily understand that various modifications and combinations may be made according to design conditions and factors without departing from the spirit and scope of the inventive concept as defined by the following claims.

The above embodiments of the inventive concept may be embodied in the form of program commands executable through various computer components, which may be recorded on a computer-readable recording medium. The computer-readable recording medium may include program commands, data files, and data structures either alone or in combination. The program commands recorded on the computer-readable recording medium may be those that are especially designed and configured for the inventive concept, or may be those that are known and available to computer programmers skilled in the art. Examples of the computer-readable recording mediums may include magnetic recording mediums such as hard disks, floppy disks, and magnetic tapes, optical recording mediums such as CD-ROMs and DVDs, magneto-optical recording mediums such as floptical disks, and hardware devices such as ROMs, RAMs and flash memories that are especially configured to store and execute program commands. Examples of the program commands may include machine language codes that may be generated by a compiler, and high-level language codes that may be executed by a computer by using an interpreter. The hardware device may be modified into one or more software modules to perform a process according to the inventive concept, and vice versa.

As described above, according to the inventive concept, since the clock synchronization may be performed even without a separate connection cable between the cameras, the physical environmental constraints such as the camera disposition and operation may be eliminated and thus the multiview images may be captured in more various environments.

Also, the hardware for separately processing the external signal may not be required and it may be applied also to the general camera equipment and thus the high scalability may be ensured.

Although the inventive concept has been described above by the drawings, certain embodiments, and particular features such as specific components, this is merely provided to promote a more comprehensive understanding of the inventive concept, the inventive concept is not limited to the above embodiments, and those of ordinary skill in the art may made various modifications therein.

Thus, the spirit of the inventive concept is not limited to the above embodiments, and the scope of the inventive concept may include both the following claims and the equivalents thereof.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A multiview camera synchronization system for controlling an exposure clock of a camera capturing a moving image at a preset frame rate, the multiview camera synchronization system comprising:
a reference value determining unit determining a reference value based on input data acquired by the camera for a first set interval;
a clock adjusting unit acquiring, for a second set interval of generating a reference signal flickering at a frequency equal to the preset frame rate, input data by the reference signal and adjusting a clock of the camera until acquiring input data equal to or greater than reference value; and
a synchronization clock setting unit setting a clock of acquiring input data of the reference value as a synchronization clock of the camera.

2. The multiview camera synchronization system of claim 1, wherein the reference signal is one of a light, a sound, a movement, and a radio frequency (RF) signal.

3. A multiview camera synchronization system for controlling an exposure clock of a camera capturing a moving image at a preset frame rate, the multiview camera synchronization system comprising:
a reference value determining unit determining a reference brightness value by calculating brightness values of images acquired by the camera for a first set interval;
a clock adjusting unit adjusting an exposure clock of the camera until acquiring an image having a brightness value equal to or greater than the reference brightness value for a second set interval of generating a reference signal flickering at a frequency equal to the preset frame rate; and
a synchronization clock setting unit setting an exposure clock of acquiring an image having a brightness value equal to or greater than the reference brightness value as a synchronization clock of the camera.

4. The multiview camera synchronization system of claim 3, wherein the reference brightness value is a maximum brightness value among the brightness values of the images acquired for the first set interval.

5. The multiview camera synchronization system of claim 3, wherein a signal longer than a frame period of the camera is generated for a certain time in the first set interval.

6. The multiview camera synchronization system of claim 3, wherein the clock adjusting unit adjusts the exposure clock by using a binary search method.

7. The multiview camera synchronization system of claim 3, wherein the clock adjusting unit repeats, until the brightness value is equal to or greater than the reference brightness value:
a first operation of calculating a brightness value of an image acquired for an exposure time of a frame period;
a second operation of determining whether the brightness value is equal to or greater than the reference brightness value; and
a third operation of adjusting an exposure clock of a next frame period forward or backward by a preset value when the brightness value is smaller than the reference brightness value.

8. The multiview camera synchronization system of claim 3, wherein the reference signal flickering at the frequency equal to the preset frame rate is a signal flickering to turn on for a time equal to the length of an exposure time of the camera.

9. The multiview camera synchronization system of claim 3, wherein the synchronization clock is used in a photographing process of the camera.

10. A multiview camera synchronization method for controlling an exposure clock of a camera capturing a moving image at a preset frame rate, the multiview camera synchronization method comprising:
a reference value determining operation of determining a reference brightness value by calculating brightness values of images acquired by the camera for a first set interval;
a clock adjusting operation of adjusting an exposure clock of the camera until acquiring an image having a brightness value equal to or greater than the reference brightness value for a second set interval of generating a reference signal flickering at a frequency equal to the preset frame rate; and
a synchronization clock setting operation of setting an exposure clock of acquiring an image having a brightness value equal to or greater than the reference brightness value as a synchronization clock of the camera.

11. The multiview camera synchronization method of claim 10, wherein the reference brightness value is a maximum brightness value among the brightness values of the images acquired for the first set interval.

12. The multiview camera synchronization method of claim 10, wherein a signal longer than a frame period of the camera is generated for a certain time in the first set interval.

13. The multiview camera synchronization method of claim 10, wherein the clock adjusting operation adjusts the exposure clock by using a binary search method.

14. The multiview camera synchronization method of claim 10, wherein the clock adjusting operation repeats, until the brightness value is equal to or greater than the reference brightness value:
a first operation of calculating a brightness value of an image acquired for an exposure time of a frame period;
a second operation of determining whether the brightness value is equal to or greater than the reference brightness value; and
a third operation of adjusting an exposure clock of a next frame period forward or backward by a preset value when the brightness value is smaller than the reference brightness value.

15. The multiview camera synchronization method of claim 10, wherein the reference signal flickering at the frequency equal to the preset frame rate is a signal flickering to turn on for a time equal to the length of an exposure time of the camera.

16. The multiview camera synchronization method of claim 10, wherein the synchronization clock is used in a photographing process of the camera.
